(19) United States
(12) Patent Application Publication
(10) Pub. No.: US 2010/0228393 A1
(43) Pub. Date: Sep. 9, 2010

(54) Neuronal network structure and method to operate a neuronal network structure

(75) Inventors: Jochen Mersmann, Stuttgart (DE); Victor Jirsa, Aubagne (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: CodeBox Computerdienste GmbH, Stuttgart (DE)

(21) Appl. No.: 12/659,782

(22) Filed: Mar. 22, 2010

Related U.S. Application Data
(63) Continuation of application No. PCT/IB2007/004176, filed on Sep. 21, 2007.

(51) Int. Cl. G05B 19/042; G06N 3/063

(52) U.S. Cl. 700/246; 706/29; 700/275; 901/1

(57) ABSTRACT

A neuronal network structure including a plurality of automata interconnected one with each other through synaptic links forming a connectivity matrix. The neural network structure acts as a machine that can be operated such that the machine shows different behaviours including periodic and non-periodic patterns, multistable patterns and more complex patterns such as spirals. A method to operate a neuronal network structure.

### TECHNICAL FIELD

The present invention relates to a neuronal network structure comprising a plurality of automata interconnected one with each other through synaptic links. The neural network structure acts as a machine that can be operated such that the machine shows different behaviours including periodic and non-periodic patterns, multistable patterns and more complex patterns such as spirals. The present invention relates to a method to operate such a neuronal network structure.

### DESCRIPTION OF THE RELATED ART

Computations based on sequentially processing architectures operate upon series of input states and generate an output state. The representation of a continuous process is foreign to such a state-based architecture and very difficult, if not impossible, to realize. To realize such a continuous process, it typically requires the digitization of the continuum into many discrete states to enable the state-based architecture to work with the input. However, most processes in nature are continuous and show lawful behaviour, such as for example the swinging of a golf club, the evolution of traffic flow, the interaction between people, and the process of thought to name just a few. The representation of such lawful and systematic behaviour as a sequence of states is artificial and only imposed by the limiting constraint of the state-based architecture, a prominent example for which is the well-known von Neumann architecture.

There have been suggestions in the literature to overcome the constraints imposed by von Neumann-type computer architectures by means of neural (or neuronal) computer architectures, also known as neural or neuronal networks or computers.

Hoppensteadt et al. discloses in “Oscillatory Neural Computers with Dynamic Connectivity” (Phys. Rev. Letters Vol. 82, 14, 2983 to 2986) a neural computer consisting of oscillators having different frequencies and being connected weakly via a common medium forced by an external input, incorporated herein by reference in its entirety. Even though such oscillators are all interconnected homogeneously, the external input imposes a dynamic connectivity, thus creating an oscillatory neural network taking into account rhythmic behaviour of the brain. The approach consists in treating the cortex as network of weakly autonomous oscillators, a selective interaction of which depends on frequencies.

“When Instability Makes Sense” by Ashwin et al. (Nature, Vol. 436, 36-37) discloses the processing of information in neural systems by means of unstable dynamics wherein the switching between states in a neural computation system is induced by instabilities, incorporated herein by reference in its entirety. The dynamics of the neural system thus explores a sequence of states, generating a specific pattern of a neural activity which for example represents a specific odour.

EP 0 401 926 B1 discloses a neuronal network structure comprising a plurality of interconnected neurons and means for information propagation among the neurons, wherein the information propagation from transmitting neurons to a receiving neuron is determined by values of synaptic coefficients assigned to neuron interconnections, in which network memory accesses of the synaptic coefficients are avoided and the number of arithmetic operations which would be at least equal to the number of input neurons in each case is reduced, incorporated herein by reference in its entirety.

Jirsa discloses in “Connectivity and dynamics of neural information processing” Neuroinformatics 2004 a neuronal network structure comprising a processing unit, an input unit for inputting variables into the processing unit, and an output unit for outputting processed variables from the processing unit, wherein the processing unit comprises a plurality of automata interconnected one with each other by means of interconnections forming a connectivity matrix. The communication between the individual automata is by means of a (typically sigmodal) response function of another automaton's state variable (see eq. 2 in Jirsa 2004), incorporated herein by reference in its entirety. No method is disclosed to operate the neural network structure. Central Pattern Generators (CPGs) are increasingly used to control the locomotion of autonomous robots, from humanoids to multi-legged insect-like robots. However, very little design methodologies are available to create CPGs for a specific task. Most of the time the design of CPGs is quite difficult since its different parameters have to be tuned by hand or by an optimization algorithm. Righetti & Ijspeert (2006) disclose how they can design a generic CPG structure in which they can encode any periodic pattern and for which generic properties come for free, such as stability against perturbations and modulation of the periodic pattern in frequency and amplitude. This information is represented in coupled oscillators and limited to periodic behaviours.

The invention includes a machine based on a neural network structure that is capable of generating a range of different behaviours including periodic, non-periodic, and multistable patterns; wherein these behaviours are robust, but flexibly configurable; and wherein the machine is composed of a neuronal network structure comprising a plurality of automata where the communication between automata is via the product of an automaton's state variable w(q) and another automaton's response function S, that is w(q)S. This modification compared to Jirsa 2004 allows accomplishing the technical effect of representing different patterns of behaviour by the same machine.

The invention further includes a method to operate the neuronal network structure by means of operating the connectivity matrix. The method to operate a network structure comprises equations 3a, 3b and 3c described herein. The technical effect that the machine produces the desired behaviour is prescribed by the process in 3b and essentially determined by f({ξᵢ(t)}). The process will be application dependent and is to be provided by the user of the machine. To accomplish the technical effect the synaptic weights cᵢⱼ are to be manipulated such that equation 3a, 3b and 3c are satisfied. This manipulation can be performed using standard procedures such as optimization algorithms or learning procedures, which are well known to the skilled person in the field (see for instance Righetti & Ijspeert 2006).

### SUMMARY

In contrast to the known neural computational architectures which are also inspired by neural sciences, but operate upon states (such as Hopfield or early Adaptive Resonance Theory (ART) networks for example), the present invention proposes a neuronal network computational architecture which is based upon processes rather than states and in which a computation is identified with the execution of a process. A “process”, contrary to a state, is the entirety of all possible behaviors of a set of time-dependent variables. A “process” is completely described by an initial condition and a rule prescribing the temporal evolution of the variables. As such time and the history of a sequence play an essential role in a “process”. For example, a threshold element describes the “process” of decision making, in which trajectories may evolve in two qualitatively different ways as a function of initial conditions. The two different ways of behaviour may be the evolution towards two different states, or a state and a periodic pattern, or more generally distinguish two or more different behaviours. The entirety of all behaviours including the initial decision making defines the “process” of this example.

The present invention addresses the technical problem of how to represent a process in a machine in a flexible but robust manner. For example, the movement patterns of a quadruped in robotic applications (for concreteness see the salamander robot of Ijspeert et al, Science, Vol. 315. no. 5817, pp. 1416-1420, 2007) require different processes for movement control as a function of gait on ground, or swimming. These processes are currently captured by either software emulations or hardware implementations as integrated circuits of each process. If in the latter representation, an electronic element malfunctions, then the entire process is dysfunctional. Hence it is technically desirable to develop a network representation of a process, which is easily reconfigurable (FLEXIBLE) to allow the representation of diverse processes with different dimensions. At the same time a network codes the process in a distributed fashion, hence the impairment of a single network node will not affect the functionality of the process (ROBUST).

The present invention finds its technical implementation in a network of automata interconnected by synaptic links. The nodes of the network are automata equivalent to neuronal populations and are characterized by their time-continuous activity (firing rate). The dynamics of the network automata is mathematically described by time-continuous dynamic systems (such as integral and/or differential equations) and can be technically implemented by basic electronic elements (such as, for example but not limited to, voltage controlled oscillators, optical oscillators, lasers or oscillators of other kinds). The synaptic links are connections between the automata and make up a connectivity matrix, which can be technically implemented by basic electronic elements, such as an integrated circuit. Jirsa (2004) disclosed that the communication between the individual automata is by means of a (typically sigmoidal) response function of another automaton's state variable. The present invention extends this realization to the following technical feature: the communication between the individual automata is by means of the product of an automaton's state variable and the response function of another automaton's state variable. This technical feature is to be included in the technical implementation of the machine via integrated circuits.

The present invention provides the technical effect of controlling the process represented in the machine, which is technically achieved by operating the connectivity matrix. “Controlling the process” is defined as operating the connectivity matrix such that a desired process is realized by the machine. All entries into the connectivity matrix are set initially to one, that is unity. Then the matrix elements are changed following the prescription of the present invention. The change of the matrix elements corresponds to the operation of the matrix and will be specific for a process. The accomplished technical effect lies therein that the output variables of the machine show the behaviour prescribed by the process. As such the network structure of automata acts as a machine that has the capability of emulating different behaviours through its output variables.

With the mechanism according to the invention, it becomes possible to define a physically existing neuronal network of N dynamic elements and to connect these elements via N² directed couplings (or interconnections). Such a neuronal network serves as the central processing unit (CPU) of a process-based architecture according to the invention. Thus, the invention devises entirely new computational paradigms. Processes (continuous sequences) will be represented in their natural framework, i.e. they will be computed in a machine working with continuous processes. One of the main advantages of the invention is the simplified treatment and solution of problems which are considered difficult in state-based architectures. Robustness of function is a further major advantage of the present architecture since function can be represented in various realisations.

Further features and embodiments will become apparent from the description and the accompanying drawings.

It will be understood that the features mentioned above and those described hereinafter can be used not only in the combination specified but also in other combinations or on their own, without departing from the scope of the present disclosure.

Various implementations are schematically illustrated in the drawings by means of an embodiment by way of example and are hereinafter explained in detail with reference to the drawings. It is understood that the description is in no way limiting on the scope of the present disclosure and is merely an illustration of a preferred embodiment.

### BRIEF DESCRIPTION OF THE DRAWINGS

FIG. 1 shows a highly schematic depiction of a neuronal network structure with process-based architecture according to the invention.

FIGS. 2A to 2C show three scenarios of the architecture of FIG. 1, illustrating the flexibility of the process-based architecture of the invention.

FIG. 3 illustrates the conceptual basis of the process-based architecture of the invention.

### DETAILED DESCRIPTION

In the context of the present application, a process is the set of all lawful behaviours which can be captured by a dynamic system, for instance a set of ordinary differential equations. It is to be noted that this is different to the mere execution of one behaviour (identical to one specific time course) for a certain initial condition.

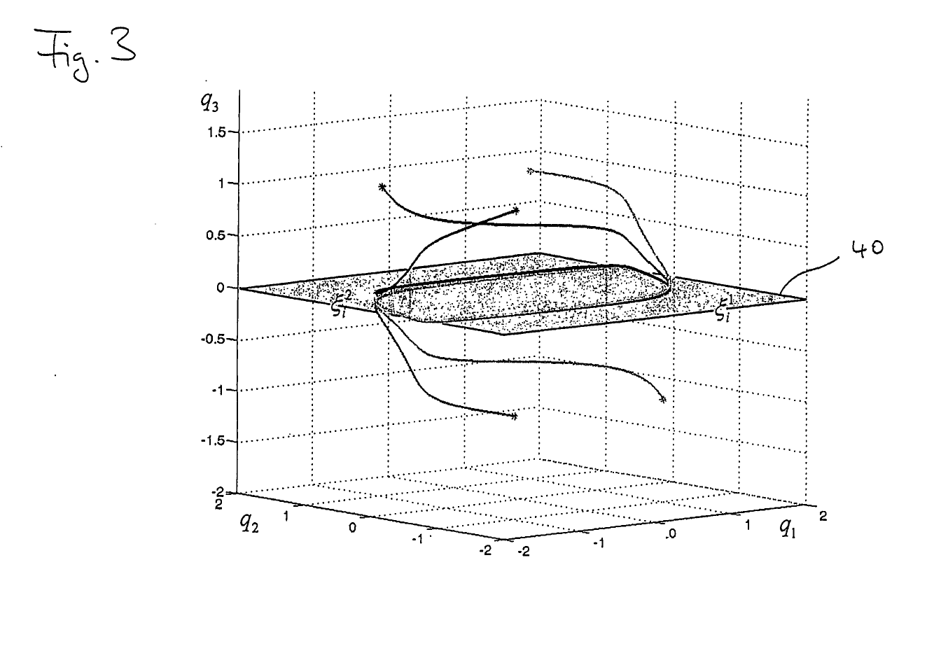

According to the invention, an m-dimensional process, described by its state variables ξε [symbol] ^{m}, arises from a high-dimensional network dynamics, described by its state variables qε [symbol] ^{N}, with dimension N>>m in a well-controlled fashion. This is achieved with a time-scale separation into a slow and fast dynamics, by means of which time-scale separation the target process arises from the full network dynamics as the slow dynamics establishes after an initial fast transient. It is captured by the so-called phase flow on the manifold (cf. FIG. 3), which can be intuitively understood to be the flow in the subspace utilized by the process within a much larger space.

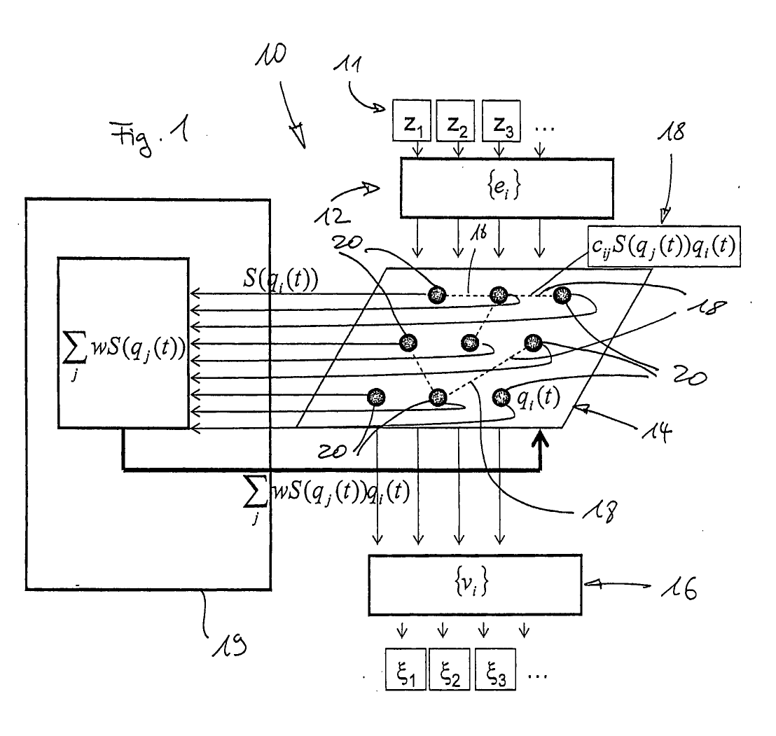

FIG. 1 shows a possible embodiment of a neuronal network structure 10 with process-based architecture according to the invention. The neuronal network structure 10 comprises an input unit 12 which is connected to a processing unit 14. An output unit 16 is connected to the processing unit 14 for outputting the results delivered by processing unit 14. The output unit 16 can also operate as storage means for storing results, or additional storage means can be provided. The neuronal network structure 10 further comprises a memory 18 for symmetry breaking patterns.

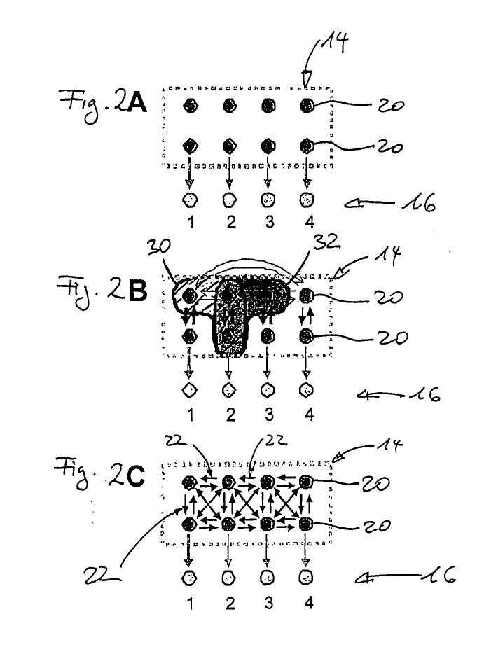

The processing unit 14 comprises a plurality of automata or nodes 20, depicted by circles (cf. also FIGS. 2A to 2C). The automata or nodes 20 are interconnected with each other by means of so-called synaptic links (cf. for example FIG. 2C), depicted with 18 and 19 in FIG. 1. Each node 20 receives the common feedback depicted with 19 as known by the person skilled in the art of neuronal networks. It is to be noted that the terms “automata” and “nodes” are to be understood as equivalents in the context of the present application.

In the following, the operation of the invention is described, referring to the figures.

The time scale separation according to the invention is accomplished through the symmetry breaking of the relative connectivity in an identically connected network of the nodes 20. Through adjustment of the symmetry of the weight differences 18, any desired low-dimensional dynamic system can be realized. If no such symmetry breaking takes place, the only coupling is via the mean field feedback 19. The low-dimensionality poses only a small constraint since most “coherent” processes in natural systems are low-dimensional despite the fact that the system per se is high-dimensional. Each node in the network of N nodes 20 shows a time continuous activity described by a (scalar or vector) variable qᵢ(t) for the i-th node and time t.

If the connectivity matrix of the network structure 14 is described by W(q)=(wᵢⱼ(q)), then the dynamics of the entire network 14 can be described by

$${\dot{q}}_{i} ( t ) = N ( {q}_{i} ( t ) ) {q}_{i} ( t ) + {\sum }_{j}^{ } {w}_{ij} ( q ) S ( {q}_{j} ( t ) ) + {I}_{i} ( {q}_{i} , t ) \qquad ( 1 )$$

where N(qᵢ(t))qᵢ(t) denotes the nonlinear intrinsic dynamics of the i-th node and S the nonlinear and adjustable transfer of information between the nodes. The dot indicates time derivative. The time-continuous input Iᵢ(qᵢ,t) is specific to each node and depends on its activity qᵢ(t).

An arbitrary external signal zᵢ(t) (shown at 11 in FIG. 1 as input signal) is spatially encoded in the i-th pattern vector eᵢ in input unit 12, where eᵢε [symbol] ^{N}. Then these multiple external signals are fed into the network 14 via

$${\sum }_{j}^{ } {z}_{j} ( t ) {e}_{j}$$

and instantiate the input signal

$${I}_{i} ( {q}_{i} , t ) ) = {a}_{i} ( {\sum }_{j}^{ } {z}_{j} ( t ) {e}_{j} ) {q}_{i}$$

at the i-th node 20. The term aᵢ denotes a linear or nonlinear function which is to be adjusted for the appropriate application.

In the following mathematical model discussion of the network structure of the invention, the input signals are dropped for simplicity of presentation. It is also to be noted that the links 22 between the automata 20 typically depend on the activity of q. This is important to enable the network to produce arbitrary processes as outlined below. For most applications, the multiplicative form of the link, wᵢⱼ(q)=wᵢⱼqᵢ with constant wᵢⱼ, is sufficient, which will be discussed in the following. Jirsa 2004 disclosed only the realization of constant wᵢⱼ, which is not sufficient to achieve the here desired technical effect.

If all network links have the same constant weight wᵢⱼ=w and wᵢⱼ(q)=wqᵢ, then it is intuitive that no node can be distinguished from the other and it can be shown that the entire network acts as a single unit. Small weight changes cᵢⱼ (as indicated by the dashed lines 18 in FIG. 1) in wᵢⱼ=w+μcᵢⱼ introduce symmetry breaking in the above dynamics which can be formulated as follows:

$${\dot{q}}_{i} ( t ) = N ( {q}_{i} ( t ) ) {q}_{i} ( t ) + {\sum }_{j}^{ } wS ( {q}_{j} ( t ) ) {q}_{i} ( t ) + {μc}_{ij} S ( {q}_{j} ( t ) ) {q}_{i} ( t ) \qquad ( 2 )$$

where μ expresses the fact that the changes are small.

The first two terms on the right side of equation (2) are the same for all nodes and generate the so-called slow manifold, if certain conditions are satisfied (see below). This manifold is the subspace, in which the i-th process ξᵢ(t), where ξᵢε [symbol] ^{m}, evolves over time. It is related to the full network dynamics by a simple linear projection

$$q ( t ) = {\sum }_{k = 1}^{m} {v}_{i}^{k} {ξ}_{i}^{k} ( t ) + {\sum }_{j = 1}^{N - m} {w}_{j} {η}_{j} ( t )$$

where q(t) is the vector q(t)=(qᵢ(t)) and νᵢ^{k} is the k-th component of the i-th vector storing the i-th slow process ξᵢ(t) in the activity distribution. The process ξᵢ(t) is comprised of m components ξᵢ^{k}(t). The high-dimensional complementary space is defined by the N-m vectors wⱼ along with the fast transient dynamics given by ηⱼ(t). Since μ is a small parameter, a time scale separation allows discussing the behaviour of the two subsystems independently as follows

$$\begin{matrix}\begin{matrix}{\dot{ξ}}_{i} ( t ) = N ( {ξ}_{i} ( t ) ) {ξ}_{i} ( t ) + {\sum }_{k}^{ } wS ( \{ {ξ}_{i}^{k} ( t ) \} ) {ξ}_{i} ( t ) & slow manifold\end{matrix} & ( 3 a ) \\ \begin{matrix}{\dot{ξ}}_{i} ( t ) = f ( \{ {ξ}_{i} ( t ) \} ) {ξ}_{i} ( t ) & slow dynamics\end{matrix} & ( 3 b ) \\ \begin{matrix}{\dot{η}}_{i} ( t ) < 0 and ( N ( {ξ}_{i} ( t ) ) + {\sum }_{k}^{ } wS ( \{ {ξ}_{i}^{k} ( t ) ) \} ) \leq 0 & fast dynamics\end{matrix} & ( 3 c )\end{matrix}$$

Here (3a) characterizes the slow manifold. This manifold is attractive if (3c) is satisfied. Note that the brackets { } in (3a) and (3c) denote the appropriate set of variables. If all links 22 are the same, that is μ=0, then the flow on the manifold is zero (cf. also FIG. 2C). This is equivalent to the statement that all nodes 20 and connections 22 are identical. If μ is not zero, then a flow is generated through 18 on the manifold captured by (3b). Since no restrictions are put upon the nature of the symmetry breaking of the connectivity, the dynamics f({ξᵢ(t)}) of the process remains arbitrary and is only determined by the pattern vectors vᵢ and the intrinsic dynamics of the automata at the network nodes 20. Or in other words, arbitrary flows are generated on the manifold by manipulating the connectivity matrix W. Or one more time in other words, an arbitrary though lawful behaviour is generated on the manifold and defines the process.

The here claimed method to operate a network structure comprises equations 3a, b and 3c. A desired behaviour of output variables is prescribed by the process in 3b and essentially determined by f({ξᵢ(t)}). To accomplish this technical effect the synaptic weights cᵢⱼ have to be manipulated such that equation 3a, 3b and 3c are satisfied. This manipulation can be performed using standard procedures such as optimization algorithms or learning procedures, which are well known to the skilled person in the field (see for instance Righetti & Ijspeert 2006).

In FIG. 2A, the upper eight nodes 20 in the network 14 are disconnected. As a consequence, the lower layer nodes generate a very specific output and map it into the numbered four nodes which serve as the output unit 16. This network is very sensitive to injuries. Particularly, if a lesion occurs, the network function will be destroyed.

FIG. 2C captures a situation in which all nodes 20 are connected by links 22 and somewhat contribute to a similar degree to the outputs 16. This architecture is robust to injuries, but does not allow sufficiently for specificity of the output. In other words, every output will be somewhat similar and no real programming is possible.

FIG. 2B describes the scenario of the invention: all nodes 20 are connected, but symmetry breaking in the connectivity 18 allows for weight changes, thus generating controlled network behaviour as characterized here by f(ξᵢ(t)).

Since f({ξᵢ(t)}) and the symmetry breaking of connectivity are not uniquely related to each other, the same function f(ξᵢ(t)) can be realized by various weight changes. In FIG. 2B, two networks are shown hatched at 30 and dotted at 32, respectively, which partially overlap (as shown hatched and dotted at 34). The identical output in output node number 2 can be generated by either the network 30 or the network 32. Such flexibility allows for robustness against errors or lesions.

FIG. 3 shows an evolution over time of initial input conditions. The diagram of FIG. 3 has three axes (q₁, q₂, and q₃ for N=3) spanning a space denoted by q₁,q₂,q₃. A planar surface 40 (m=2) defines a manifold spanned by the variables ξ₁=(ξ₁¹,ξ₁²) of the i-th process. Five initial conditions are plotted and indicated by five respective asterisks. As time evolves, the system's state vector q(t)=(q₁(t),q₂(t),q₃(t)) traces out trajectories which move fast to the manifold. Once on the manifold, the dynamics is slower and the trajectories follow a circular flow within the manifold. Hence the emerging process ξᵢ(t)) approximates the total network dynamics q(t).

In order to provide a better understanding of the novel process-based architecture of the invention, established notions and terms in state-based computation are compared in the following with the operation of the invention.

A ‘computation’ is the execution of a process as prescribed by equation (3b). It is implemented in the network connectivity for μ≠0.

‘Memory’ is the ability to recreate the same dynamic process prescribed by the equations (3a) to (3c) and is foremost defined by the symmetry breaking in the connectivity wᵢⱼ.

‘Encoding’ of processes occurs by breaking the connectivity weights such that equation (3c) holds.

‘Input’ to the network is given as a set of values which will determine the initial conditions for the process to be executed; alternatively, while the process is being executed, these input values can change as a function of time themselves and the process will change accordingly. A metaphor illustrating this could be the following: Two dancers move in a coordinated fashion. One dancer represents the input stream, the other the CPU process. As a function of the first dancer, the second dancer will coordinate his/her dance movements; equivalently, as a function of the behaviour of the input stream, the CPU process will alter its dynamics.

‘Output’ is the read-out of the network and occurs by extracting ξᵢ from the network dynamics q, typically by projecting q onto the adjoint coordinate system of vᵢ.

WO 2009/037526 is incorporated herein by reference in its entirety.

1. A neuronal network structure, comprising
a processing unit;
an input unit for inputting variables into the processing unit; and
an output unit for outputting processed variables from the processing unit;
wherein the processing unit comprises a plurality of automata interconnected one with each other by means of interconnections forming a connectivity matrix, with
each of said automata having the same time-continuous dynamics in absence of interconnections prescribed by a typically nonlinear function composed of a product of the automaton's state variable and another nonlinear function of the automaton's state variable;
each of said interconnections being dependent on state variables, whereas the deviations from identical interconnections across all automata are small;
the neuronal network structure further having a process-based architecture, a process-based architecture meaning that the processing unit generates a low-dimensional time-continuous dynamics described as the process, said process being the set of all lawful behaviors of a given phase flow on a manifold.

2. The neuronal network structure according to claim 1, wherein the interconnections are dependent on state variables.

3. The neuronal network structure according to claim 1, wherein a process to be processed by the process-based processing unit is defined by a dynamic system such as a set of differential equations.

4. The neuronal network structure according to claim 1, wherein the processing unit captures a lower dimensional dynamics of a given process.

5. The neuronal network structure according to claim 4, wherein the processing unit captures a lower dimensional dynamics of a given process by means of a time-scale separation.

6. The neuronal network structure according to claim 1, wherein a controlled network behaviour in the processing unit is achieved by symmetry breaking of connectivity.

7. The neuronal network structure of claim 6, wherein the processing unit adjusts weight differences of the interconnections in order to obtain symmetry breaking.

8. A neuronal network structure comprising a processing unit, an input unit for inputting variables into the processing unit, and an output unit for outputting processed variables from the processing unit, wherein the processing unit comprises a plurality of automata interconnected one with each other by means of identical interconnections forming a connectivity matrix, and wherein the neuronal network structure has a process-based architecture.

9. A neuronal network structure composed of a network of automata interconnected by synaptic links, the neuronal network structure comprising nodes forming the network, said nodes being said automata equivalent to neuronal populations, said synaptic links being connections between said automata; wherein the dynamics of said network automata are defined by time-continuous dynamic systems and a process is determined by the entirety of the temporal behaviours of said network nodes or automata which may have an arbitrarily large complexity, thus forming a cognitive architecture.

10. A method to operate a neuronal network structure with a plurality of automata interconnected one with each other by means of identical interconnections forming a connectivity matrix, the operation being process-based.

11. The method according to claim 10, wherein the interconnections are dependent on state variables.

12. The method according to claim 10, wherein a process to be processed is defined by a dynamic system such as a set of differential equations.

13. The method according to claim 10, comprising the step of capturing a lower dynamics of a given process.

14. The method according to claim 13, wherein the step of capturing comprises performing a time-scale separation.

15. The method according to claim 10, comprising the step of symmetry breaking of connectivity.

16. The method according to claim 15, wherein the step of symmetry breaking comprises adjusting weight differences of the interconnections.

17. A method of operating a neuronal network, comprising
inputting, by an input unit of the neuronal network, variables into a processing unit of the neuronal network, the processing unit comprising a plurality of automata interconnected one with each other by interconnections forming a connectivity matrix;
generating, by the processing unit, low-dimensional time-continuous dynamics described as a process, said process being a set of all lawful behaviors of a given phase flow on a manifold;
outputting, by an output unit of the neuronal network, processed variables from the processing unit; and
controlling movement of a machine based on the processed variables output from the processing unit.

18. The method according to claim 17, wherein the movement includes periodic and non-periodic patterns.

19. The method according to claim 17, wherein the movement is the locomotion of an autonomous robot.
